(19) United States
(12) Patent Application Publication
(10) Pub. No.: US 2025/0014309 A1
(43) Pub. Date: Jan. 9, 2025

(54) IMAGE PROCESSING METHOD, IMAGE PROCESSING DEVICE, ELECTRONIC APPARATUS AND STORAGE MEDIUM

(71) Applicant: Samsung Electronics Co., Ltd., Suwon-si (KR)

(72) Inventor: Wenjuan LIU, Suwon-si (KR)

(73) Assignee: Samsung Electronics Co., Ltd., Suwon-si (KR)

(21) Appl. No.: 18/450,715

(22) Filed: Aug. 16, 2023

(30) Foreign Application Priority Data
Jul. 3, 2023 (CN) 2023 1 0804826.2

(51) Int. Cl. G06V 10/60; G06T 5/20; G06T 5/40

(52) U.S. Cl. CPC G06V 10/60; G06T 5/20; G06T 5/40; G06T 2207/10024

(57) ABSTRACT

The present disclosure provides an image processing method, an image processing device, an electronic apparatus, and a storage medium. The image processing method includes determining a dark channel image of an input image; determining an atmospheric luminosity according to a grayscale histogram of the dark channel image; determining a dehazing image of the input image based on the atmospheric luminosity.

### CROSS-REFERENCE TO RELATED APPLICATION

This application claims priority from Chinese Patent Application No. 202310804826.2 filed on Jul. 3, 2023 in the Chinese Intellectual Property Office, and all the benefits accruing therefrom under 35 U.S.C. 119, the contents of which in its entirety are herein incorporated by reference.

### TECHNICAL FIELD

The present disclosure relate to the fields of image processing, and more specifically, to image processing methods, image processing devices, electronic apparatuses, and storage mediums.

### BACKGROUND

Usually, images taken in hazy weather may be degraded due to influence of atmospheric light. Since the images taken in hazy weather are grayish white and have less edge information, a detectability of the images will be greatly reduced. Therefore, it is of great practical importance to study image dehazing. In a related image dehazing process, when there is a scene containing a similar-white area (e.g., a white object) or a sky area in a hazy image, problems such as image oversaturation, blur on a boundary area, color distortion in the sky area, and excessive dehazing, may occur.

The above information is presented only as background technical information to help understand the present disclosure. No decision or assertion has been made as to whether any of the above contents can be applied as the prior art of the present disclosure.

### SUMMARY

Some example embodiments of the present disclosure are to provide image processing methods, image processing devices, electronic apparatuses, and storage mediums to at least address the above problems and/or disadvantages.

According to some aspects of some example embodiments of the present disclose, an image processing method is provided, which includes determining a dark channel image of an input image; determining an atmospheric luminosity according to a grayscale histogram of the dark channel image; and determining a dehazing image of the input image based on the atmospheric luminosity.

In some example embodiments, the determining the atmospheric luminosity according to the grayscale histogram of the dark channel image includes obtaining the grayscale histogram of the dark channel image based on counting pixels of the dark channel image; and determining the atmospheric luminosity by performing a grayscale traversal on the grayscale histogram.

In some example embodiments, the determining the atmospheric luminosity by performing the grayscale traversal on the grayscale histogram includes filtering the grayscale histogram; obtaining a first point satisfying a first condition in a first direction, by traversing the filtered grayscale histogram along the first direction, wherein the first direction is a direction of grayscale reduction; determining whether there is a second point that corresponds to a, the second point further satisfying a second condition, by continuing to traverse the filtered grayscale histogram from the first point along the first direction; and; determining a grayscale value corresponding to the first point based on determining an absence of the second point, or the second point based on determining an existence of the second point, as the atmospheric luminosity.

In some example embodiments, the determining the grayscale value corresponding to the first based on determining an absence of the second point, or the second point based on determining an existence of the second point includes based on there being the second point that corresponds to the valley and satisfies the second condition, determining a grayscale value corresponding to the second point which is an initial second point in the first direction as the atmospheric luminosity; and based on there being no second point that corresponds to the valley and satisfies the second condition, determining a grayscale value corresponding to the first point as the atmospheric luminosity.

In some example embodiments, the first condition is that a number of pixels corresponding to the first point is greater than or equal to a first threshold, and the second condition is that a number of pixels corresponding to the second point is less than or equal to a second threshold and a grayscale value corresponding to the second point is greater than or equal to a third threshold.

In some example embodiments, the determining the dehazing image of the input image based on the atmospheric luminosity includes determining a transmissivity based on a luma image of the input image and the atmospheric luminosity; determining a transmissivity mapping weight based on the transmissivity; determining a dehazing luma image based on the luma image, the atmospheric luminosity and the transmissivity mapping weight; and determining the dehazing image based at least on a chroma image of the input image and the dehazing luma image.

In some example embodiments, the determining the transmissivity based on the luma image of the input image and the atmospheric luminosity includes determining a base transmissivity based on the luma image and the atmospheric luminosity; obtaining a refined transmissivity based on the base transmissivity; obtaining the transmissivity based on the refined transmissivity.

In some example embodiments, the determining the transmissivity based on the luma image of the input image and the atmospheric luminosity further includes determining a fourth threshold for transmissivity update based on the atmospheric luminosity, wherein the fourth threshold is a value greater than 0 and less than or equal to 1; and determining the greater one of the transmissivity and the fourth threshold as an updated transmissivity.

In some example embodiments, the determining the dehazing image based at least on the chroma image of the input image and the dehazing luma image includes determining a fusion weight based on the atmospheric luminosity and the luma image; and obtaining the dehazing image by applying an enhancement saturation value and the fusion weight to the chroma image and the dehazing luma image.

According to some aspects of some example embodiments of the present disclose, an image processing device, includes a dark channel image determination unit configured to determine a dark channel image of an input image; an atmospheric luminosity determination unit configured to determine an atmospheric luminosity according to a grayscale histogram of the dark channel image; and a dehazing processing unit configured to determine a dehazing image of the input image based on the atmospheric luminosity.

In some example embodiments, the atmospheric luminosity determination unit is configured to determine the atmospheric luminosity according to the grayscale histogram of the dark channel image based on obtaining the grayscale histogram of the dark channel image based on counting pixels of the dark channel image; and determining the atmospheric luminosity by performing a grayscale traversal on the grayscale histogram.

In some example embodiments, the atmospheric luminosity determination unit is configured to determine the atmospheric luminosity by performing the grayscale traversal on the grayscale histogram based on filtering the grayscale histogram; obtaining a first point firstly satisfying a first condition in a first direction, by traversing the filtered grayscale histogram along the first direction, wherein the first direction is a direction of grayscale reduction; determining whether there is a second point that corresponds to a valley, the second point further satisfying a second condition, by continuing to traverse the filtered grayscale histogram from the first point along the first direction; and determining a grayscale value corresponding to the first point based on determining an absence of the second point, or the second point based on determining an existence of the second point, as the atmospheric luminosity.

In some example embodiments, the atmospheric luminosity determination unit is configured to determine the grayscale value corresponding to the first point based on determining an absence of the second point, or the second point based on determining an existence of the second point, as the atmospheric luminosity according to determining a grayscale value corresponding to the second point which is an initial second point in the first direction as the atmospheric luminosity, based on there being the second point that corresponds to the valley and satisfies the second condition; and determining a grayscale value corresponding to the first point as the atmospheric luminosity, based on there being no second point that corresponds to the valley and satisfies the second condition.

In some example embodiments, the first condition is that a number of pixels corresponding to the first point is greater than or equal to a first threshold, and the second condition is that a number of pixels corresponding to the second point is less than or equal to a second threshold and a grayscale value corresponding to the second point is greater than or equal to a third threshold.

In some example embodiments, the dehazing processing unit is configured to determine the dehazing image of the input image based on the atmospheric luminosity based on determining a transmissivity based on a luma image of the input image and the atmospheric luminosity; determining a transmissivity mapping weight based on the transmissivity; determining a dehazing luma image based on the luma image, the atmospheric luminosity and the transmissivity mapping weight; and determining the dehazing image based at least on a chroma image of the input image and the dehazing luma image.

In some example embodiments, the dehazing processing unit is configured to determine the transmissivity based on the luma image of the input image and the atmospheric luminosity based on determining a base transmissivity based on the luma image and the atmospheric luminosity; obtaining a refined transmissivity based on the base transmissivity; and obtaining the transmissivity based on the refined transmissivity.

In some example embodiments, the dehazing processing unit is further configured to determine the transmissivity based on the luma image of the input image and the atmospheric luminosity according to determining a fourth threshold for transmissivity update based on the atmospheric luminosity, wherein the fourth threshold is a value greater than 0 and less than or equal to 1; and determining the greater one of the transmissivity and the fourth threshold as an updated transmissivity.

In some example embodiments, the dehazing processing unit is configured to determine the dehazing image based at least on the chroma image of the input image and the dehazing luma image according to determining a fusion weight based on the atmospheric luminosity and the luma image; and obtaining the dehazing image by applying an enhancement saturation value and the fusion weight to the chroma image and the dehazing luma image.

According to some aspects of some example embodiments of the present disclose, an electronic apparatus is provided, which includes at least one processor; at least one non-volatile memory configured to store computer executable instructions, wherein the computer executable instructions, based on being executed by the at least one processor, cause the at least one processor to perform the image processing method as described above.

According to some aspects of some example embodiments of the present disclose, a computer-readable storage medium is provided, wherein, instructions in the computer-readable storage medium, based on being executed by at least one processor, cause the at least one processor to perform the image processing method as described above.

The image processing method, image processing device, electronic apparatus, and storage medium according to some example embodiments of the present disclosure can determine a atmospheric luminosity considering whether an image contains a sky area, to provide data with high accuracy for a subsequent image processing, and the processing process is simple without adding additional and excessive calculations, thereby effectively optimizing an effect of image processing while saving computational costs, for example in processing time, processing resources, power consumption, component degradation, etc. The image processing method, image processing device, electronic apparatus, and storage medium according to some example embodiments of the present disclosure can achieve an improved dehazing effect by a dehazing processing of a dark primary-color without introducing a color anomaly in the sky area. The image processing method, image processing device, electronic apparatus, and storage medium according to some example embodiments of the present disclosure can improve a dehazing intensity of a boundary transition area of the sky area, making an overall effect of the processed image more natural. The image processing method, image processing device, electronic apparatus, and storage medium according to some example embodiments of the present disclosure can be applied, or well adapted to many image processing scenarios, for example, an application scenario with a sky area having a large area.

It should be understood that the above general description and the following detailed description are only illustrative and explanatory, and do not limit the present disclosure.

### BRIEF DESCRIPTION OF THE DRAWINGS

The above and other aspects, features and advantages of some example embodiments disclosed herein will be more apparent through the following description in combination with the accompanying drawings, in which

FIG. 1 is a flowchart illustrating an image processing method according to some example embodiments of the present disclosure;

FIG. 2 is a flow chart illustrating a processing of a grayscale traversal according to some example embodiments of the present disclosure;

FIG. 3 is a flow chart illustrating a processing of determining a dehazing image based on an atmospheric luminosity according to some example embodiments of the present disclosure;

FIG. 4 is a block diagram illustrating an image processing device according to some example embodiments of the present disclosure; and

FIG. 5 is a block diagram illustrating an electronic apparatus according to some example embodiments of the present disclosure.

### DETAILED DESCRIPTION

In order to enable those ordinary skill in the art to better understand the technical concepts of the present disclosure, the technical concepts in the example embodiments of the present disclosure are described clearly and completely in conjunction with the accompanying drawings.

The example embodiments and terms used with respect to some example embodiments are not intended to limit the techniques described herein to specific embodiments, and should be understood to include various modifications, equivalents and/or alternatives of some example embodiments. As used herein, each of descriptions such as “A or B”, “at least one of A or B”, “at least one of A and B”, “A, B or C”, “at least one of A, B and C” and “at least one of A, B or C” may include all possible combinations of items listed together with the corresponding one of the plurality of descriptions. As used herein, terms such as “first” and “second” may be used to simply distinguish the corresponding item from another item, and do not limit the item in other aspects (e.g., importance or order).

A conventional image dehazing method is generally a dehazing method relying on a dark channel prior. However, it is revealed that, by statistics of tens of thousands of fog-free natural images, for a clear and fog-free natural image of a non-sky scene/non-white scene, there are always one or more pixels in which at least one of three RGB color channels has a very low grayscale value, for example, close to zero, in any one local area thereof, and a channel with the lowest grayscale value among the three RGB color channels may be referred to as a dark channel. Although some example embodiments refer to the RGB color channels, the present disclosure is not limited thereto and other color channels may be used. A conventional dehazing method of dark channel prior may include an estimation of an atmospheric luminosity, a calculation of a transmissivity, and an image recovery processing as following

First, a dehazing model used for the dehazing processing is shown in an Equation (1).

$$I ( x ) = J ( x ) \tilde{t} ( x ) + A ( 1 - \tilde{t} ( x ) ) \qquad ( 1 )$$

Wherein, I(x) denotes an observed hazy image, J(x) denotes a fog-free image, e.g., a target image, A denotes an atmospheric luminosity (which can also be referred to as an atmospheric light value), \tilde{t}(x) denotes a transmissivity, and x denotes the pixel point.

An aim of the conventional dehazing method is to recover the fog-free image J(x) from the hazy image I(x). In the conventional dehazing method of dark channel prior, a dark channel image J^{dark}(x) is calculated from an original image by an Equation (2).

$${J}^{dark} ( x ) = {min}_{y ∈ Ω ( x )} ( {min}_{c} {J}^{c} ( y ) ) = 0 \qquad ( 2 )$$

Wherein, Ω(x) denotes a square window centered on pixel point x, and J^{C}(y) denotes an image of any one of the color channels in the fog-free image J, that is, c denotes one of the three RGB color channels, wherein y denotes a pixel point belonging to a range of Ω(x).

A usual process of the estimation of the atmospheric luminosity mainly includes acquiring pixels with the pixel value in the first 0.1% of the dark channel image according to a magnitude of luminance, searching for points corresponding to the acquired pixels in the original hazy image, and determining a luminance value of the point with the highest luminance among the searched points as a value of the atmospheric luminosity A. Generally, the atmospheric luminosity is taken to be 255.

After determining the atmospheric luminosity, the transmissivity is calculated by an Equation (3).

$$\tilde{t} ( x ) = 1 - ω {min}_{y ∈ Ω ( x )} ( {min}_{c} \frac{{I}^{c} ( y )}{{A}^{c}} ) \qquad ( 3 )$$

Wherein, the parameter ω is a parameter used to adjust a degree of dehazing, which is a value greater than or equal to 0 and less than or equal to 1, when ω is 0, it indicates no dehazing, and when ω is 1, it indicates completely dehazing.

Finally, the hazy image is recovered to the fog-free image by an Equation (4).

$$J ( x ) = \frac{I ( x ) - A}{max ( \tilde{t} ( x ) , {t}_{0} )} + A \qquad ( 4 )$$

Wherein the constant value t₀ is introduced to avoid overexposure of the fog-free image J, t₀ is usually 0.1.

Dehazing may be achieved by a conventional dehazing method of dark channel prior, but since the dehazing method of dark channel prior is a statistical-based processing method that relies on statistical results of a large number of fog-free photographs, and there are limitations in the application of this method. For example, in a case in which there is an area similar to the atmospheric light scenario (e.g., a similar-white pattern area with a large area) or a sky area in the image, the conventional dehazing method of dark channel prior does not process such hazy images, so the conventional dehazing method of dark channel prior will not achieve satisfactory results for such hazy images. For example, for the above-mentioned hazy images, the problem of failure of the dark channel prior rule may occur, resulting in phenomenon such as image oversaturation, blur on a boundary area, and color distortion acutely visible in the sky area.

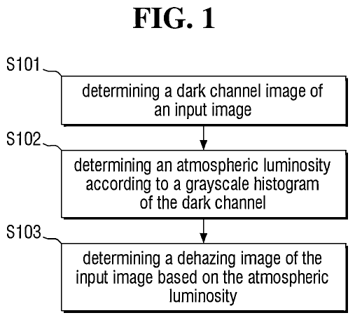

In summary, a dehazing image processing for the hazy images having a scenario similar to the atmospheric light scenario is particularly important in a case that the related image processing methods have a greater risk of dehazing failure and the application of dehazing processing is more limited. The present disclosure proposes an image processing method, an image processing device, an electronic apparatus, and a storage medium for determining the atmospheric luminosity based on a histogram of a dark channel image, taking into account the above-mentioned problems of related technologies. The image processing method, image processing device, electronic apparatus, and storage medium according to some example embodiments of the present disclosure will be described in detail below with reference to FIGS. 1 to 4.

It should be understood that the above application scenarios are intended as examples only, and some example embodiments according to the present disclosure are not limited to the above application scenarios. In the following, for ease of description, although performing a processing on an image considering a sky area is described according to some example embodiments of the present disclosure, it will be understood by those ordinary skill in the art that the description is given as exemplary only and that the sky area may include, but is not limited to, any other image areas. In addition, in the following, a luma image may refer to an image in a luminance domain or a luma component (Y) of the corresponding image, and a chroma image may refer to an image in a chromaticity domain or a chroma component (UV) of the corresponding image.

Firstly, the image processing method according to some example embodiments of the present disclosure will be described with reference to FIGS. 1 to 3.

FIG. 1 is a flowchart illustrating an image processing method according to some example embodiments of the present disclosure.

Referring to FIG. 1, at operation S101, a dark channel image of an input image is determined. Here, the input image according to some example embodiments of the present disclosure may include a hazy image that will be image processed, for example, but not limited to, an original image I in a RGB format. For example, the dark channel image J^{dark} of the input image I in the RGB format may be calculated by the above Equation (2), and the description is not repeated here.

At operation S102, an atmospheric luminosity is determined according to a grayscale histogram of the dark channel image. According to some example embodiments of the present disclosure, the atmospheric luminosity may include a grayscale value of a brightest point in a non-sky area. Since grayscale histograms of different dark channel images may vary widely, the atmospheric luminosity according to some example embodiments of the present disclosure may be determined based on the grayscale histograms of the dark channel images.

According to some example embodiments of the present disclosure, the determining the atmospheric luminosity according to the grayscale histogram of the dark channel image may include obtaining the grayscale histogram of the dark channel image by counting pixels of the dark channel image based on the respective pixels grayscale (or grayscale value), and determining the atmospheric luminosity by performing a grayscale traversal on the grayscale histogram.

For example, the grayscale histogram of the dark channel image may be used to represent a relationship between a frequency of occurrence of each grayscale and the grayscale in the dark channel image. A horizontal coordinate of the grayscale histogram may represent a grayscale or grayscale value and is a value between 1 and 255, as the higher the grayscale, the higher the brightness. A vertical coordinate of the grayscale histogram may represent the number of pixels and may reflect a frequency of occurrence of pixels having the same grayscale value, as the greater the number of pixels corresponding to a certain grayscale value, the higher the frequency of occurrence of the pixels corresponding to this grayscale value.

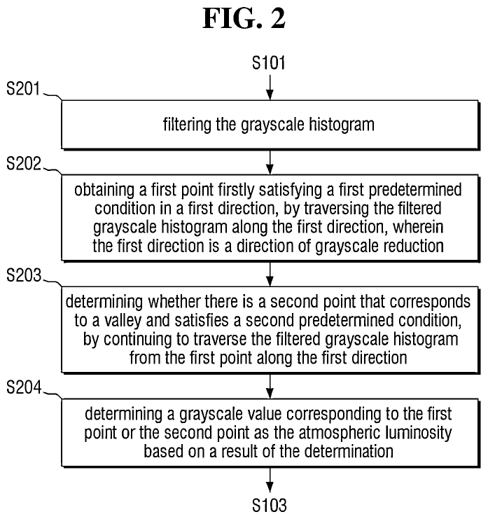

In the case that the grayscale histogram of the dark channel image is obtained, the atmospheric luminosity for subsequent image processing may be determined by performing the grayscale traversal on the grayscale histogram, and the determining the atmospheric luminosity by performing the grayscale traversal on the grayscale histogram are described in detail below with reference to FIG. 2.

FIG. 2 is a flowchart illustrating a processing of a grayscale traversal according to some example embodiments of the present disclosure. FIG. 2 illustrates a description of operation S102 of FIG. 1

Referring to FIG. 2, according to some example embodiments of the present disclosure, from operation S101 of FIG. 1, at operation S201, the grayscale histogram is filtered. For example, firstly, the obtained grayscale histogram of the dark channel image may be filtered to obtain a smooth curve. For example, a filtering method includes, but is not limited to, a Gaussian filtering, and a filtered grayscale histogram that may maintains more of an original shape may be obtained by filtering the grayscale histogram using the Gaussian filtering, which is a simple filtering processing.

Then, in a case that the filtered grayscale histogram is obtained, the filtered grayscale histogram may be traversed along a first direction of grayscale reduction, that is, along a horizontal axis of the grayscale histogram from a brightest value to a lowest value (e.g., a direction of grayscale reduction), to search for a candidate point for determining the atmospheric luminosity. According to some example embodiments of the present disclosure, the candidate point for determining the atmospheric luminosity may be defined as a brightest point in a non-sky area, and may include, but are not limited to, a brightest point in the non-sky area when there is a sky area in the image and/or a brightest point in the overall image when there is no sky area in the image.

At operation S202, a first point firstly satisfying a first condition in a first direction is obtained, by traversing the filtered grayscale histogram along the first direction, wherein the first direction is a direction of grayscale reduction.

For example, according to some example embodiments of the present disclosure, a point firstly having the number of pixels greater than or equal to a first threshold (e.g., the point firstly having a vertical coordinate greater than or equal to the first threshold along the opposite direction of the horizontal axis) in the traversal processing may be determined as the first point, which may be considered as the brightest point of the overall image when there is no sky area in the image (e.g., including, but not limited to, a case that the sky area does not exist in the image, or an influence on image processing by the sky area in the image may be ignored). According to some example embodiments of the present disclosure, the first condition may be, but is not limited to, the number of pixels corresponding to the first point is greater than or equal to the first threshold. Here, the first threshold may be an empirically preset, or, alternatively, desired or selected, value, for example, a first threshold is 10, 12, etc.

In the case that the first point is determined, the traversal processing continues from the first point along the first direction of grayscale reduction. At operation S203, whether there is a second point that corresponds to a valley and satisfies a second condition is determined, by continuing to traverse the filtered grayscale histogram from the first point along the first direction.

For example, according to some example embodiments of the present disclosure, it may be determined whether there is a second point satisfying the second condition among one or more points corresponding to one or more valleys (e.g., one or more valleys from the first point along the opposite direction of the horizontal axis) in the continuing traversal processing, wherein the one or more points may be considered as one or more brightest points of a non-sky area when there is a sky area in the image (e.g., including, but not limited to, a case that the sky area exists in the image, or an influence on image processing by the sky area in the image must be took into account), that is, whether there is a second point satisfying the second condition among the one or more brightest points in the above case is determined.

An accuracy of determining the atmospheric luminosity using the second point with taking into account the sky area may be higher than an accuracy of determining the atmospheric luminosity using a first point without taking into account the sky area. However, during the image processing, the original image does not always include the sky area, and in this case, the atmospheric luminosity may not have the higher accuracy if the second point is used to determine the atmospheric luminosity. In addition, a plurality of brightest points corresponding to the valleys may be determined, however, only one of the brightest points may be the brightest point used for a reference of the atmospheric luminosity. Therefore, by using the second condition, it may be determined whether there is a second point that satisfies the second condition among the one or more points corresponding to the one or more valleys, and thus, a grayscale value corresponding to the first point or the second point is determined as the atmospheric luminosity having the higher accuracy based on the result of the determination of the second point existing or not existing.

At operation S204, the grayscale value corresponding to the first point or the second point is determined as the atmospheric luminosity based on the result of the determination of the second point existing or not existing of operation S203.

According to some example embodiments of the present disclosure, the determining the grayscale value corresponding to the first point or the second point as the atmospheric luminosity based on the result of the determination may include if there is the second point that corresponds to the valley and satisfies the second condition, determining a grayscale value corresponding to a second point which is the first one in the first direction as the atmospheric luminosity, and if there is no second point that corresponds to the valley and satisfies the second condition, determining a grayscale value corresponding to the first point as the atmospheric luminosity. According to some example embodiments of the present disclosure, the second condition may be, but is not limited to, a number of pixels corresponding to the second point being less than or equal to a second threshold and a grayscale value corresponding to the second point being greater than or equal to a third threshold. In some example embodiments the second threshold and the third threshold may be an empirically preset, or alternatively, desired or selected, value, for example, the second threshold may be 160 and the third threshold may be 128.

For example, the existence of the second point that corresponds to a valley and satisfies the second condition may indicate the existence of a qualified brightest point of the non-sky area. For example, the brightest point of the non-sky area suitable for determining the atmospheric luminosity may be the grayscale value corresponding to the second point which is the first one in the first direction of grayscale reduction, Therefore, in some example embodiments, the second point may be used to determine the atmospheric luminosity. The absence of the second point that corresponds to the valley and satisfies the second condition may indicate that the non-sky area does not exist or that the brightest point of the non-sky area has not been successfully found. Therefore, in some example embodiments it may be considered that there is no brightest point of the sky area, and the grayscale value corresponding to the first point may be used to determine the atmospheric luminosity. As such, the estimation of the atmospheric luminosity by traversal processing improves the conventional atmospheric luminosity estimation method that selects the first 0.1% of pixels, for example, by improving the selection criteria of the atmospheric luminosity as described according to some example embodiments.

By the image processing method according to some example embodiments of the present disclosure, it is possible to determine the atmospheric luminosity considering whether the image contains the sky area, provide data with high accuracy for a subsequent image processing, and the processing method is simple without increasing additional and excessive calculations, thereby effectively optimizing and/or improving an effect of image processing while saving computational costs. For example, power usage, processing time, and/or life efficiency of electrical components may be improved based on the processing methods described in the present disclosure.

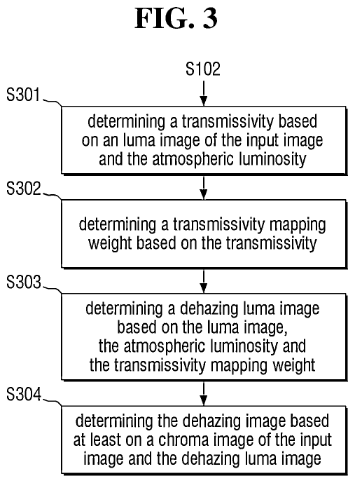

At operation S103, following operation S204, a dehazing image of the input image is determined based on the atmospheric luminosity. The determining the dehazing image of the input image based on the atmospheric luminosity will be described in detail below with reference to FIG. 3.

FIG. 3 is a flowchart illustrating a processing of determining a dehazing image based on an atmospheric luminosity according to some example embodiments of the present disclosure. FIG. 3 illustrates a description of operation S103 of FIG. 1.

Referring to FIG. 3, according to some example embodiments of the present disclosure, from operation S102, at operation S301, a transmissivity is determined based on a luma image of the input image and the atmospheric luminosity. In some example embodiments, in the case that the input image is an RGB image, the RGB image may be converted into the luma image and a chroma image of the input image, the dehazing processing is performed based on the luma image of the input image, and finally the chroma image of the input image is combined with the dehazing luma image to determine a final dehazing image. An RGB image may refer to an image including image data related to red (R), green (G), and blue (B) color levels, in additional to as one of ordinary skill in the art would understand. A luma image may refer to an image including image data related to brightness, or black and white, or achromatic levels, in additional to as one of ordinary skill in the art would understand. A chroma image may refer to an image including image data related to color levels, in additional to as one of ordinary skill in the art would understand.

According to some example embodiments of the present disclosure, the determining the transmissivity based on the luma image of the input image and the atmospheric luminosity may include determining a base transmissivity based on the luma image and the atmospheric luminosity, obtaining a refined transmissivity based on the base transmissivity, and obtaining the transmissivity based on the refined transmissivity.

For example, in some example embodiments, the base transmissivity t_{base} is determined based on the luma image and the atmospheric luminosity by an Equation (5).

$${t}_{base} = 1 - ω \times Y / A \qquad ( 5 )$$

Wherein ω is a parameter for adjusting a degree of dehazing, which is a value, preset empirically, or alternatively, desired or selected, and may be less than or equal to 1 and greater than or equal to 0, for example, ω may be 0.9, Y is the luma image of the input image, and A is the atmospheric luminosity determined at operation S102.

Then, the refined transmissivity is obtained by filtering the base transmissivity. For example, a filtering method included, but are not limited to, a guided filtering.

Then, the transmissivity used for the image processing is determined by taking an absolute value of the refined transmissivity.

In addition, if the transmissivity is too small, it may cause the final obtained fog-free image to be overexposed and a noise will be more obvious. Therefore, a fourth threshold may be used in order to avoid the calculated transmissivity being too small, the fourth threshold being set to determine a proper, or minimum, transmissivity. According to some example embodiments of the present disclosure, the determining the transmissivity based on the luma image of the input image and the atmospheric luminosity may further include determining a fourth threshold for transmissivity update based on the atmospheric luminosity, wherein the fourth threshold is a value greater than 0 and less than or equal to 1, and determining the greater one of the transmissivity and the fourth threshold as a updated transmissivity.

For example, the fourth threshold T₄ may be determined by the following Equation (6).

$${T}_{4} = min ( 1 - A / 256 + T\_p , 1 ) \qquad ( 6 )$$

Wherein T_p is a constant value preset empirically, or alternatively, desired or selected, and A is the atmospheric luminosity determined at operation S102.

As such, by the transmissivity determination processing taking into account the degree of the dehazing and a lower limit of the transmissivity, the more appropriate transmissivity may be determined and the value of transmissivity may be adjusted, for example, in a timely or rapid manner, thereby improving the accuracy of the image processing, avoiding excessive dehazing of the recovered fog-free image caused by transmissivity that is too small, and improving resource allocation of, for example, processing circuitry configured to perform the transmissivity determination. The above determination of the transmissivity according to some example embodiments of the present disclosure is only exemplary, and those skilled in the art may also determine the transmissivity by any other suitable manners.

At operation S302, a transmissivity mapping weight is determined based on the transmissivity. For example, the transmissivity mapping weight w_t may be determined based on the transmissivity determined at operation S301, by an Equation (7).

$$W\_t = 1 - a \times log ( t ) \qquad ( 7 )$$

Wherein t is the transmissivity determined as described above, a is a constant value preset empirically, for example, a may be 1.5.

At operation S303, a dehazing luma image is determined based on the luma image, the atmospheric luminosity, and the transmissivity mapping weight. For example, the luma image is calculated based on the atmospheric luminosity and the transmissivity mapping weight determined according to the methods as described above, to obtain the dehazing luma image. According to some example embodiments of the present disclosure, the dehazing luma image Y_d may be determined by an Equation (8).

$$Y\_d = ( Y - A ) \times w\_t + A \qquad ( 8 )$$

Wherein A is the atmospheric luminosity determined/updated at operation S102, and Y is the luma image of the input image.

Then, at operation S304, the dehazing image is determined based at least on the chroma image of the input image and the dehazing luma image. In other words, in the case that the dehazing luma image is determined, the final dehazing image is determined based on the chroma image and the dehazing luma image.

According to some example embodiments of the present disclosure, the determining the dehazing image based at least on the chroma image of the input image and the dehazing luma image includes determining a fusion weight based on the atmospheric luminosity and the luma image, and obtaining the dehazing image by applying an enhancement saturation value and the fusion weight to the chroma image and the dehazing luma image.

For example, the fusion weight according to some example embodiments of the present disclosure may be a value that is used to measure a degree of fusion of the dehazing luma image. As an example, the fusion weight wₐ may be determined by an Equation (9).

$$\{ \begin{matrix}{w}_{a} = 0 & when Y > A + deta \\ {w}_{a} = 1 & when Y < A - deta \\ {w}_{a} - \frac{Y - A + deta}{2 \times deta} & when A - deta \leq Y \leq A + deta\end{matrix} \qquad ( 9 )$$

Wherein A is the atmospheric luminosity determined at operation S102, Y is the luma image of the input image, and deta is a constant value preset empirically, or alternatively, desired or selected.

Then, the luma image J_Y and chroma images J_U and J_V of the dehazing image are determined by an Equation (10).

$$\{ \begin{matrix}J\_Y = Y\_d \times {w}_{a} + Y \times ( 1 - {w}_{a} ) \\ J\_U = U \times ( 1 + sat \times {w}_{a} ) \\ J\_V = V \times ( 1 + sat \times {w}_{a} )\end{matrix} \qquad ( 10 )$$

Wherein U is a U component of the chroma image, V is a V component of the chroma image, and sat is an enhancement saturation value for enhancing a saturation of the chroma image, which may be a value preset empirically, or alternatively, desired or selected, and, for example, may be a value between 0.5 and 1.

As such, the final dehazing image is determined by considering the fusion weight and enhancement saturation to improve recovering the fog-free image and reduce the influence of the image processing on the original image.

In summary, according to some example embodiments of the present disclosure, firstly, the atmospheric luminosity may be determined by processing the RGB image of the input image, and then the chroma image and the dehazing luma image may be determined, for example, by processing a YUV image of the input image based on the atmospheric luminosity, so that the dehazing image is finally obtained.

The image processing method according to some example embodiments of the present disclosure can achieve an improved dehazing effect by a dehazing processing of a dark primary-color while maintaining a consistent sky color, for example, without introducing an abnormal color in the sky area. The image processing method according to some example embodiments of the present disclosure can improve a dehazing intensity of a boundary transition area of the sky area, making an overall effect of the processed image more natural. The image processing method according to some example embodiments of the present disclosure can be applied and/or well adapted to many image processing scenarios, for example, an image processing scenario with a sky area having a large area.

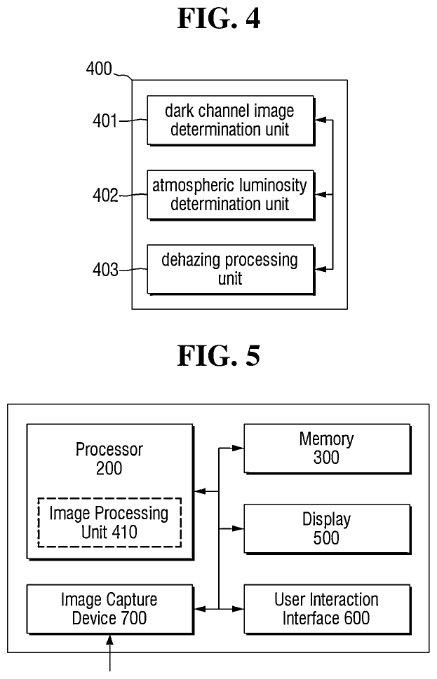

FIG. 4 is a block diagram illustrating an image processing device according to some example embodiments of the present disclosure.

Referring to FIG. 4, an image processing device 400 according to some example embodiments of the present disclosure may include a dark channel image determination unit 401, an atmospheric luminosity determination unit 402, and a dehazing processing unit 403.

The dark channel image determination unit 401 according to some example embodiments of the present disclosure may be configured to determine a dark channel image of an input image. The atmospheric luminosity determination unit 402 according to some example embodiments of the present disclosure may be configured to determine an atmospheric luminosity according to a grayscale histogram of the dark channel image. The dehazing processing unit 403 according to some example embodiments of the present disclosure may be configured to determine a dehazing image of the input image based on the atmospheric luminosity.

That is, the dark channel image determination unit 401 may perform an operation corresponding to the operation S101 of the image processing method as described above with reference to FIG. 1, the atmospheric luminosity determination unit 402 may perform an operation corresponding to the operation S102 of the image processing method as described above with reference to FIGS. 1 and 2, and the dehazing processing unit 403 may perform an operation corresponding to the operation S103 of the image processing method as described above with reference to FIGS. 1 and 3.

According to some example embodiments, the dark channel image determination unit 401 and/or the image processing device 400 may receive input image data of an input image. The input image data may contain image data relating to a hazy image. The input image data may contain or be accompanied by a signal, a command, data, or other feature indicating the image processing device 400 and/or dark channel image determination unit 401 to perform the process described with relation to FIG. 1 and other example embodiments above. That is, the image processing device 400 may perform the disclosed operations on received image data.

In some example embodiments, the dark channel image determination unit 401 may perform an operation corresponding to the operation S101 of the image processing method as described above with reference to FIG. 1, and may transmit the determined dark channel image, for example, to the atmospheric luminosity determination unit 402.

According to some example embodiments of the present disclosure, the atmospheric luminosity determination unit 402 may receive the transmitted, determined dark channel image from the dark channel image determination unit 401. In some example embodiments, atmospheric luminosity determination unit 402 is configured to determine the atmospheric luminosity according to the grayscale histogram of the dark channel image by obtaining the grayscale histogram of the dark channel image by counting pixels of the dark channel image based on the respective pixel's grayscale value, and determining the luminosity by performing a grayscale traversal on the grayscale histogram.

According to some example embodiments of the present disclosure, the atmospheric luminosity determination unit 402 is configured to determine the atmospheric luminosity by performing the grayscale traversal on the grayscale histogram by filtering the grayscale histogram, obtaining a first point firstly satisfying a first condition in a first direction, by traversing the filtered grayscale histogram along the first direction, wherein the first direction is a direction of grayscale reduction, determining whether there is a second point that corresponds to a valley and satisfies a second condition, by continuing to traverse the filtered grayscale histogram from the first point along the first direction, and determining a grayscale value corresponding to the first point or the second point as the atmospheric luminosity based on a result of the determination. In some example embodiments, the atmospheric luminosity determination unit 402 may transmit the determined atmospheric luminosity, for example, to the dehazing processing unit 403.

According to some example embodiments of the present disclosure, the atmospheric luminosity determination unit 402 is configured to determine the grayscale value corresponding to the first point or the second point as the atmospheric luminosity based on the result of the determination by if there is the second point that corresponds to the valley and satisfies the second condition, determining a grayscale value corresponding to a second point which is the first one in the first direction as the atmospheric luminosity, and if there is no second point that corresponds to the valley and satisfies the second condition, determining a grayscale value corresponding to the first point as the atmospheric luminosity. In some example embodiments, the atmospheric luminosity determination unit 402 may transmit the determined atmospheric luminosity, for example, to the dehazing processing unit 403.

According to some example embodiments of the present disclosure, the first condition is that the number of pixels corresponding to the first point is greater than or equal to a first threshold, and the second condition is that the number of pixels corresponding to the second point is less than or equal to a second threshold and the grayscale value corresponding to the second point is greater than or equal to a third threshold.

According to some example embodiments of the present disclosure, the dehazing processing unit 403 may receive the transmitted, determined atmospheric luminosity, for example, from the atmospheric luminosity determination unit 402. According to some example embodiments of the present disclosure, the dehazing processing unit 403 is configured to determine the dehazing image of the input image based on the atmospheric luminosity by determining a transmissivity based on a luma image of the input image and the atmospheric luminosity, determining a transmissivity mapping weight based on the transmissivity, determining a dehazing luma image based on the luma image, the atmospheric luminosity and the transmissivity mapping weight, and determining the dehazing image based at least on a chroma image of the input image and the dehazing luma image. According to some example embodiments of the present disclosure, the dehazing processing unit 403 is configured to output the dehazing image and/or dehazing image data of the input image to the outside, for example, a processor and/or display of an electronic device which is not shown herein. In some example embodiments, the dehazing processing unit 403 may transmit the dehazing image data of the dehazing image to the outside, for example, a processor and/or display of an electronic device which is not shown herein.

According to some example embodiments of the present disclosure, the dehazing processing unit 403 is configured to determine the transmissivity based on the luma image of the input image and the atmospheric luminosity by determining a base transmissivity based on the luma image and the atmospheric luminosity, obtaining a refined transmissivity based on the base transmissivity, and obtaining the transmissivity based on the refined transmissivity.

According to some example embodiments of the present disclosure, the dehazing processing unit 403 is further configured to determine the transmissivity based on the luma image of the input image and the atmospheric luminosity by determining a fourth threshold for transmissivity update based on the atmospheric luminosity, wherein the fourth threshold is a value greater than 0 and less than or equal to 1, and determining the greater one of the transmissivity and the fourth threshold as a updated transmissivity.

According to some example embodiments of the present disclosure, the dehazing processing unit 403 is configured to determine the dehazing image based at least on the chroma image of the input image and the dehazing luma image by determining a fusion weight based on the atmospheric luminosity and the luma image, and obtaining the dehazing image by applying an enhancement saturation value and the fusion weight to the chroma image and the dehazing luma image.

With respect to the image processing device 400 in the above embodiments, the specific manners in which each unit performs the operations has been described in detail in some example embodiments of the related image processing method, and will not be described in detail here.

In addition, it should be understood that each unit in the image processing device 400 according to some example embodiments of the present disclosure may be implemented as a hardware component and/or a software component. Those skilled in the art may, for example, use a field programmable gate array (FPGA) or an application specific integrated circuit (ASIC) to implement each unit according to the defined processing performed by each unit. In some example embodiments, the dark channel image determination unit 401, the atmospheric luminosity determination unit 402, and the dehazing processing unit 403 may be implemented as individual components, or may be combined with one another. In some example embodiments, one of the dark channel image determination unit 401, the atmospheric luminosity determination unit 402, and the dehazing processing unit 403 may perform some or all of the functions of another one of the dark channel image determination unit 401, the atmospheric luminosity determination unit 402, and the dehazing processing unit 403 as disclosed above.

FIG. 5 is a block diagram illustrating an electronic apparatus according to some example embodiments of the present disclosure.

Referring to FIG. 4, an electronic apparatus 10 is further provided. The electronic apparatus 10 may include at least one processor 200, and at least one memory 300 including at least one non-volatile memory unit storing computer executable instructions, wherein the computer executable instructions, when being executed by the at least one processor 200, cause the at least one processor 200 to perform the image processing method as described above. That is, the processor 200 may include the image processing unit 410 corresponding to the image processing device 400 of FIG. 4, and may perform the functions thereof, or, alternatively, the processor 200 may instruct the image processing device 400 to perform the image processing method as described above.

According to some example embodiments of the present disclosure, the electronic apparatus may be a PC computer, a tablet device, a personal digital assistant, a smartphone, and/or other devices capable of executing the above set of instructions. Here, the electronic apparatus does not have to be a single electronic apparatus, but may also be an assembly of any device or circuit that may execute the above instructions (or instruction sets) individually or jointly. The electronic apparatus may also be a part of an integrated control system or system manager, or may be configured as a portable electronic apparatus that is interfaced with a local or remote (e.g., via wireless transmission).

In electronic apparatus, the processor 200 may include a central processing unit (CPU), a graphics processor (GPU), a programmable logic device, a dedicated processor system, a microcontroller, and/or a microprocessor. As an example, but not a limitation, the processor 200 may also include an analog processor, a digital processor, a microprocessor, a multi-core processor, a processor array, a network processor, and the like.

The processor 200 may execute instructions or codes stored in the memory 300, where the memory 300 may also store data. Instructions and data may also be transmitted and received through a network via a network interface device, wherein the network interface device may use any known transmission protocol.

The memory 300 may include volatile memory, and be integrated with the processor as a whole, for example, RAM or a flash memory is arranged in an integrated circuit microprocessor or the like. In addition, the memory 300 may include an independent device, such as an external disk drive, a storage array, or other storage device that may be used by any database system. The memory 300 and the processor 200 may be operatively coupled, or may communicate with each other, for example, through an I/O port, a network connection, or the like, so that the processor may read files stored in the memory.

In addition, the electronic apparatus 10 may also include a video display 500 (such as a liquid crystal display) and a user interaction interface 600 (such as one or more of a keyboard, a mouse, a touch input device, etc.). All components of the electronic apparatus may be connected to each other via a bus and/or a network (not shown).

Further, in some example embodiments, the electronic apparatus 10 may include an image capture device 700, the image capture device 700 capable of collecting, or otherwise generating image data corresponding to an image. The image may correspond to the hazy image discussed above, and the image data may correspond to the image data discussed above. In some example embodiments, there the electronic apparatus 10 has no image capture device 700 and may receive image data externally.

In some example embodiments, some or all of the video display 500, user interaction interface 600, and/or image capture device 700 may be excluded from the electronic apparatus 10.

According to some example embodiments of the present application, there may also be provided a computer-readable storage medium (corresponding to the memory 300), wherein, instructions in the computer-readable storage medium, when being executed by at least one processor 200, cause the at least one processor to perform the image processing method as described above.

According to some example embodiments of the present disclosure, examples of the computer-readable storage medium include a read only memory (ROM), a random access programmable read only memory (PROM), an electrically erasable programmable read only memory (EEPROM), a random access memory (RAM), dynamic random access memory (DRAM), a static random access memory (SRAM), a flash memory, a non-volatile memory, a CD-ROM, a CD-R, a CD+R, a CD-RW, a CD+RW, a DVD-ROM, a DVD-R, a DVD+R, a DVD-RW, a DVD+RW, a DVD-RAM, a BD-ROM, a BD-R, a BD-R LTH, a BD-RE, a Blu-ray or an optical disc storage, a hard disk drive (HDD), a solid state hard disk (SSD), a card memory (such as a multimedia card, a secure digital (SD) card, or an extreme digital (XD) card), a magnetic tape, a floppy disk, a magneto-optical data storage device, an optical data storage device, a hard disk, a solid state disk, and any other devices configured to store computer applications and any associated data, data files and data structures in a non-transitory manner, and provide the computer programs and any associated data, data files and data structures to a processor or computer so that the processor or computer can execute the computer programs. The computer programs in the above-mentioned computer readable storage medium can be executed in an environment deployed in an electronic apparatus such as a client, a host, a proxy device, a server, etc. in addition, in some example embodiments, the computer programs and any associated data, data files and data structures are distributed over networked computer systems so that the computer programs and any associated data, data files and data structures are stored, accessed and executed in a distributed manner by one or more processors or computers.

After considering the description and practicing the present invention disclosed herein, those skilled in the art may recognize other embodiments of the present disclosure. The present application intends to cover any variation, use or adaptation of the present disclosure, which follow general principles of the present disclosure and include the common general knowledge or frequently used technical means in the technical field, which are not disclosed in the present disclosure. The description and the example embodiments are only regarded as examples, and the true scope and spirit of the present disclosure are indicated by the claims.

The first and second conditions and saturation values may be variously selected, determined, predetermined, or desired. For example, the various conditions may be predetermined in in the image processing device, or may be determined based on image generating hardware, or otherwise selected based on the present disclosure and as understood by one of ordinary skill in the art.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

It should be understood that the present disclosure is not limited to the precise structure described above and shown in the drawings, and various modifications and changes may be made without departing from its scope. The scope of the present disclosure is limited only by the claims.

1. An image processing method, comprising:
determining a dark channel image of an input image;
determining an atmospheric luminosity according to a grayscale histogram of the dark channel image; and
determining a dehazing image of the input image based on the atmospheric luminosity.

2. The image processing method according to claim 1, wherein the determining the atmospheric luminosity according to the grayscale histogram of the dark channel image comprises:
obtaining the grayscale histogram of the dark channel image based on counting pixels of the dark channel image; and
determining the atmospheric luminosity by performing a grayscale traversal on the grayscale histogram.

3. The image processing method according to claim 2, wherein the determining the atmospheric luminosity by performing the grayscale traversal on the grayscale histogram comprises:
filtering the grayscale histogram;
obtaining a first point satisfying a first condition in a first direction, by traversing the filtered grayscale histogram along the first direction, wherein the first direction is a direction of grayscale reduction;
determining whether there is a second point that corresponds to a valley, the second point further satisfying a second condition, by continuing to traverse the filtered grayscale histogram from the first point along the first direction; and
determining a grayscale value corresponding to the first point based on determining an absence of the second point, or the second point based on determining an existence of the second point, as the atmospheric luminosity.

4. The image processing method according to claim 3, wherein the determining the grayscale value corresponding to the first point based on determining an absence of the second point, or the second point based on determining an existence of the second point comprises:
based on there being the second point that corresponds to the valley and satisfies the second condition, determining a grayscale value corresponding to the second point which is an initial second point in the first direction as the atmospheric luminosity; and
based on there being no second point that corresponds to the valley and satisfies the second condition, determining a grayscale value corresponding to the first point as the atmospheric luminosity.

5. The image processing method according to claim 3, wherein
the first condition is that a number of pixels corresponding to the first point is greater than or equal to a first threshold, and
the second condition is that a number of pixels corresponding to the second point is less than or equal to a second threshold and a grayscale value corresponding to the second point is greater than or equal to a third threshold.

6. The image processing method according to claim 1, wherein the determining the dehazing image of the input image based on the atmospheric luminosity comprises:
determining a transmissivity based on a luma image of the input image and the atmospheric luminosity;
determining a transmissivity mapping weight based on the transmissivity;
determining a dehazing luma image based on the luma image, the atmospheric luminosity, and the transmissivity mapping weight; and
determining the dehazing image based at least on a chroma image of the input image and the dehazing luma image.

7. The image processing method according to claim 6, wherein the determining the transmissivity based on the luma image of the input image and the atmospheric luminosity comprises:
determining a base transmissivity based on the luma image and the atmospheric luminosity;
obtaining a refined transmissivity based on the base transmissivity; and
obtaining the transmissivity based on the refined transmissivity.

8. The image processing method according to claim 7, wherein the determining the transmissivity based on the luma image of the input image and the atmospheric luminosity further comprises:
determining a fourth threshold for transmissivity update based on the atmospheric luminosity, wherein the fourth threshold is a value greater than 0 and less than or equal to 1; and
determining the greater one of the transmissivity and the fourth threshold as an updated transmissivity.

9. The image processing method according to claim 6, wherein the determining the dehazing image based at least on the chroma image of the input image and the dehazing luma image comprises:
determining a fusion weight based on the atmospheric luminosity and the luma image; and
obtaining the dehazing image by applying an enhancement saturation value and the fusion weight to the chroma image and the dehazing luma image.

10. An image processing device, comprising:
a dark channel image determination unit configured to determine a dark channel image of an input image;
an atmospheric luminosity determination unit configured to determine an atmospheric luminosity according to a grayscale histogram of the dark channel image; and
a dehazing processing unit configured to determine a dehazing image of the input image based on the atmospheric luminosity.

11. The image processing device according to claim 10, wherein the atmospheric luminosity determination unit is configured to determine the atmospheric luminosity according to the grayscale histogram of the dark channel image based on:
obtaining the grayscale histogram of the dark channel image based on counting pixels of the dark channel image; and
determining the atmospheric luminosity by performing a grayscale traversal on the grayscale histogram.

12. The image processing device according to claim 11, wherein the atmospheric luminosity determination unit is configured to determine the atmospheric luminosity by performing the grayscale traversal on the grayscale histogram based on:
filtering the grayscale histogram;
obtaining a first point satisfying a first condition in a first direction, by traversing the filtered grayscale histogram along the first direction, wherein the first direction is a direction of grayscale reduction;
determining whether there is a second point that corresponds to a valley, the second point further satisfying a second condition, by continuing to traverse the filtered grayscale histogram from the first point along the first direction; and
determining a grayscale value corresponding to the first point based on determining an absence of the second point, or the second point based on determining an existence of the second point, as the atmospheric luminosity.

13. The image processing device according to claim 12, wherein the atmospheric luminosity determination unit is configured to determine the grayscale value corresponding to the first point based on determining an absence of the second point, or the second point based on determining an existence of the second point, as the atmospheric luminosity according to:
determining a grayscale value corresponding to the second point which is an initial second point in the first direction as the atmospheric luminosity, based on there being the second point that corresponds to the valley and satisfies the second condition; and
determining a grayscale value corresponding to the first point as the atmospheric luminosity, based on there being no second point that corresponds to the valley and satisfies the second condition.

14. The image processing device according to claim 12, wherein
the first condition is that a number of pixels corresponding to the first point is greater than or equal to a first threshold, and
the second condition is that a number of pixels corresponding to the second point is less than or equal to a second threshold and a grayscale value corresponding to the second point is greater than or equal to a third threshold.

15. The image processing device according to claim 10, wherein the dehazing processing unit is configured to determine the dehazing image of the input image based on the atmospheric luminosity based on:
determining a transmissivity based on a luma image of the input image and the atmospheric luminosity;
determining a transmissivity mapping weight based on the transmissivity;
determining a dehazing luma image based on the luma image, the atmospheric luminosity, and the transmissivity mapping weight; and
determining the dehazing image based at least on a chroma image of the input image and the dehazing luma image.

16. The image processing device according to claim 15, wherein the dehazing processing unit is configured to determine the transmissivity based on the luma image of the input image and the atmospheric luminosity according to:
determining a base transmissivity based on the luma image and the atmospheric luminosity;
obtaining a refined transmissivity based on the base transmissivity; and
obtaining the transmissivity based on the refined transmissivity.

17. The image processing device according to claim 16, wherein the dehazing processing unit is further configured to determine the transmissivity based on the luma image of the input image and the atmospheric luminosity according to:
determining a fourth threshold for transmissivity update based on the atmospheric luminosity, wherein the fourth threshold is a value greater than 0 and less than or equal to 1; and
determining the greater one of the transmissivity and the fourth threshold as an updated transmissivity.

18. The image processing device according to claim 15, wherein the dehazing processing unit is configured to determine the dehazing image based at least on the chroma image of the input image and the dehazing luma image based on:
determining a fusion weight based on the atmospheric luminosity and the luma image; and
obtaining the dehazing image by applying an enhancement saturation value and the fusion weight to the chroma image and the dehazing luma image.

19. An electronic apparatus, comprising:
at least one processor;
at least one non-volatile memory configured to store computer executable instructions,
wherein the computer executable instructions, based on being executed by the at least one processor, cause the at least one processor to perform the image processing method according to claim 1.

20. (canceled)
